(19) United States
(12) Patent Application Publication
(10) Pub. No.: US 2025/0217115 A1
(43) Pub. Date: Jul. 3, 2025

(54) COMBINATORIC CODE GENERATION FOR TRAINING ARTIFICIAL INTELLIGENCE SYSTEMS

(71) Applicant: INTERNATIONAL BUSINESS MACHINES CORPORATION, ARMONK, NY (US)

(72) Inventors: ANDREW C. M. HICKS, HIGHLAND, NY (US); RYAN LO, POUGHKEEPSIE, NY (US); MICHAEL GAGLIARDI, SOMERSET, MA (US)

(21) Appl. No.: 18/397,433

(22) Filed: Dec. 27, 2023

(51) Int. Cl. G06F 8/35; G06F 40/20

(52) U.S. Cl. CPC G06F 8/35; G06F 40/20

(57) ABSTRACT

Systems and methods for combinatoric code generation for training artificial intelligence systems, comprising reducing a plurality of code portion combinations to a subset of code portion combinations that satisfy one or more constraints using a combinatorial reduction, generating one or more synthetic programs using the subset of code portion combinations, and training an artificial intelligence system using the synthetic programs.

### BACKGROUND

The present disclosure relates to methods, apparatus, and products for combinatoric code generation for training artificial intelligence systems. Modern computer environments can involve use of artificial intelligence systems that require extensive configuration for use. For example, some artificial intelligence systems include artificial intelligence or machine learning models that are made up of various algorithms. These algorithms need to be trained on particular data sets in order to serve purposes such as prediction, analysis, or the like. The training data sets can often be large, complex, and difficult to generate or maintain. For different types of data, such as data that is not raw text and is structured in some other way, there may be limitations on how the data can be generated or obtained and how much of the data is usable by the artificial intelligence or machine learning models. Moreover, obtaining the training data can pose other challenges, particularly in cases where the data is not freely available to any user and requires permission or licensing to obtain.

### SUMMARY

According to embodiments of the present disclosure, various methods, apparatus and products for combinatoric code generation for training artificial intelligence systems are described herein. In some aspects, combinatoric code generation for training artificial intelligence systems includes reducing a plurality of code portion combinations to a subset of code portion combinations that satisfy one or more constraints using a combinatorial reduction, generating one or more synthetic programs using the subset of code portion combinations, and training an artificial intelligence system using the synthetic programs.

### BRIEF DESCRIPTION OF THE DRAWINGS

FIG. 1 sets forth a block diagram of an example computing environment for combinatoric code generation for training artificial intelligence systems in accordance with some embodiments of the present disclosure.

FIG. 2 sets forth a flowchart of an example method for combinatoric code generation for training artificial intelligence systems in accordance with some embodiments of the present disclosure.

FIG. 3 sets forth a flowchart of another example method for combinatoric code generation for training artificial intelligence systems in accordance with some embodiments of the present disclosure.

FIG. 4 sets forth a flowchart of another example method for combinatoric code generation for training artificial intelligence systems in accordance with some embodiments of the present disclosure.

FIG. 5 sets forth a flowchart of another example method for combinatoric code generation for training artificial intelligence systems in accordance with some embodiments of the present disclosure.

### DETAILED DESCRIPTION

The disclosure herein includes systems and methods for combinatoric code generation for training artificial intelligence systems. The generation of synthetic programs can include generating combinations of code portions of computer code. In many cases, the set of combinations can quickly comprise a very large number of possible combinations. Accordingly, the set of combinations can be reduced to another set, where the reduced set may have particular characteristics. The reduced set of combinations can then be combined or recombined in various ways to generate synthetic programs or code files. In particular, the programs can then be used as training data for an artificial intelligence system, such as for training a large language model (LLM). The LLM can be an LLM that is trained to output other synthetic code that is, for example, generated as a translation of code from one programming language to code in another programming language.

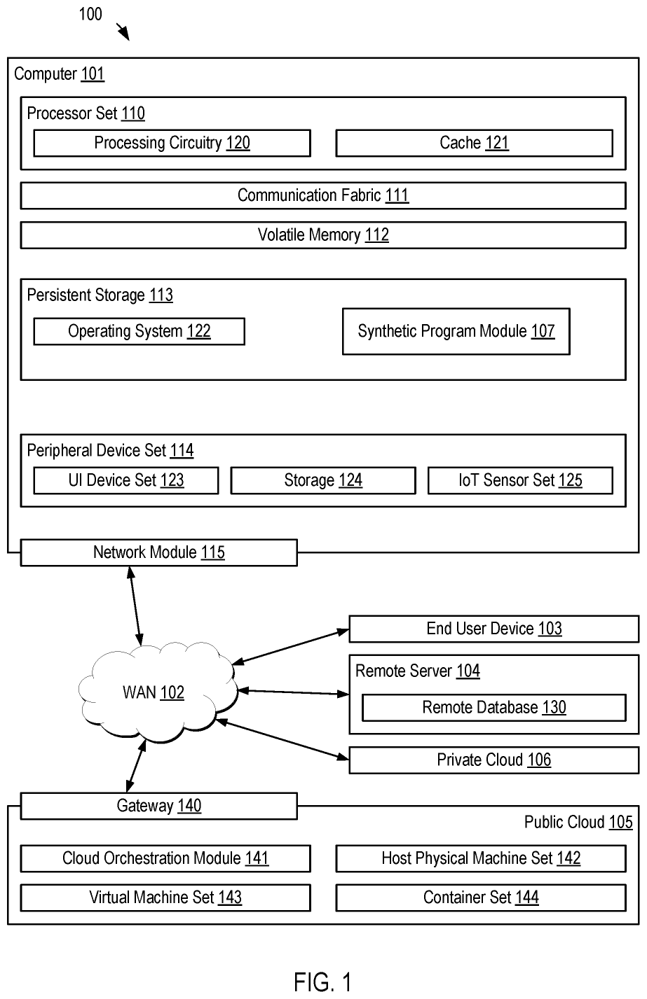

FIG. 1 sets forth an example computing environment according to aspects of the present disclosure. Computing environment 100 contains an example of an environment for the execution of at least some of the computer code involved in performing the various methods described herein, such as synthetic program module 107. In addition to synthetic program module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and synthetic program module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in synthetic program module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in synthetic program module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

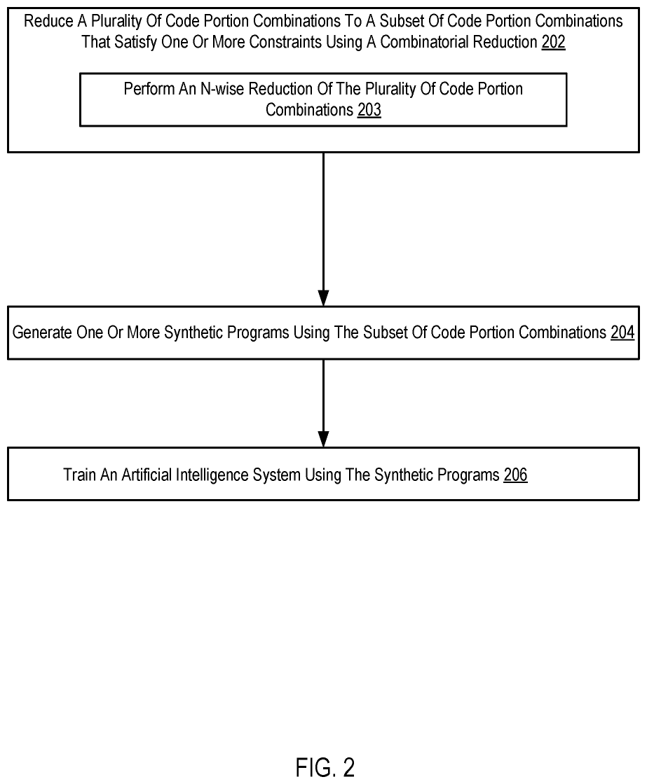

FIG. 2 sets forth a flowchart of an example method for combinatoric code generation for training artificial intelligence systems in accordance with some embodiments of the present disclosure. The method of FIG. 2 may be performed, for example, by the synthetic program module 107 of FIG. 1. In some embodiments, the synthetic program module 107 may be implemented as a process or service separate from an application or software implementing combinatoric code generation for training artificial intelligence systems. For example, the synthetic program module 107 may be implemented by an operating system or other software that monitors the behavior and execution of an application implementing combinatoric code generation for training artificial intelligence systems. As another example, in some embodiments, the synthetic program module 107 may be implemented as a process or service that applies updates or patches to applications or code capable of implementing combinatoric code generation for training artificial intelligence systems, or as a process or service that monitors or detects updates or patches to applications or code capable of combinatoric code generation for training artificial intelligence systems.

The method of FIG. 2 includes reducing 202 a plurality of code portion combinations to a subset of code portion combinations that satisfy one or more constraints using a combinatorial reduction. In some embodiments, synthetic program module 107 obtains code files to use for generating code combinations. The code files may be, for example, part of a software suite or platform (e.g., an operating system). The code files may represent complete programs, such as a program for memory management that is used as part of an operating system.

In some embodiments, the code files are split up into a number of code snippets or code portions. The splitting can be performed in various ways. For example, the code file may be broken down by individual function, individual code block, class, method, or the like. As another example, the code file may be split into code portions using certain characters or bits of code as delimiters (e.g., the curly bracket ‘{’ or ‘}’ characters). Synthetic program module 107 can be configured to take a code file as input and decompose it into various code portions. Synthetic program module 107 can also assign metadata to each code portion. For example, the code portion metadata can include code portion identifiers, parent code file identifiers, descriptions of what the code portion does, code authors, and so on.

As an example, a memory management code file can be split into several code portions according to individual functions performed by different sections of the memory management code file. For example, different code portions may be generated for sections of the memory management code file such as the memory allocation function, the memory deallocation to free memory function, the garbage collection function, and so on. As a more specific example, the memory management code file can be a COBOL code file.

In some embodiments, the resulting code portions are recombined into different code portion combinations that can be designed as new synthetic programs. Each code portion or groups of code portions can form a constituent part of a code portion combination that then can become an executable program. The code portions may be combinable in different ways. In general, it may be appreciated that a set of x elements can be combined in x! ways or a factorial of x. Moreover, if p elements are being chosen from q sets of elements, the number of combinations can be a Cartesian product, or pa (which can also be expressed as p\hat{ }q, or p raised to the power q). Readers will appreciate that a factorial of the set of elements or even the Cartesian product can result in a number that quickly gets very large as the number of elements grows. As an example, where there are 8 elements, or code portions, the number of possible combinations can be 8! or 40,320. Where 2 elements are to be chosen from 8 sets of elements, for example, the Cartesian product is 256, and where 2 elements are to be chosen from only 20 sets of elements, the Cartesian product results in over a million possible combinations. Even where generating a large number of code portion combinations is possible, it may be impractical to use this number of combinations as synthetic programs for training an artificial intelligence system. Moreover, if combinations are regenerated each time new code portions are added, this may result in an inefficient and burdensome process of constantly regenerating a large number of combinations.

In some embodiments, the Cartesian product of code portion combinations is reduced in one or more ways. The method of FIG. 2 includes performing 203, an n-wise reduction of the number of combinations of the Cartesian product. In this embodiment, n corresponds to a subset of elements that are to be chosen from the complete set of elements for inclusion in a code portion combination. As an example, n may equal 2, resulting in a 2-wise, or pair-wise reduction of the number of combinations of the Cartesian product. Purely as an example, it may be considered that there are 8 sets of elements, each set having a pair of elements. As in, there may be 8 sets of code portions, where each set includes 2 different code portions. As a more specific example, each code portion in a set may correspond to a different variation of a particular function or operation. For instance, a set of the code portions may correspond to two different functions that each perform memory allocation, such as memalloc1 and memalloc2. The two memory allocation functions may have been derived from the same source code file or from different source code files (e.g., the same or different COBOL source code files). In other words, the variants of memory allocation functions can each form a component part of a synthetic program that is later usable as a memory management program.

Continuing with the example above, recall that the Cartesian product can be 256 for 8 sets of elements each having two elements. Where a pairwise reduction is performed, a combination formula can be applied as shown below:

$$( \begin{matrix}a \\ b\end{matrix} ) = \frac{a !}{b ! ( a - b ) !}$$

In the formula shown above, n represents the total number of sets (in this case, 8 pairs, or a=8), and b represents the number of elements that are being chosen for each combination (in this case, b=2). Using these values, a result of the formula can be a subset of code portion combinations of 28, thereby reducing the plurality of code portion combinations (e.g., 256) to a subset of code portion combinations (e.g., 28). Moreover, synthetic program module 107 can be configured to further reduce the subset of 28 code portion combinations using other techniques, such as the use of a binary decision diagram. Readers will appreciate that the addition of other constraints can result in a slightly larger set that is still smaller than the set given by the Cartesian product. Without constraints, arriving at the set (e.g., 28) can be considered an np-hard problem, whereas with particular constraints, the resulting set may be a result of an np-incomplete process.

The method of FIG. 2 also includes generating 204 one or more synthetic programs using the subset of code portion combinations. Generating one or more synthetic programs using the subset of code portion combinations can include generating a complete synthetic program or executable code file using a code portion combination from the subset of code portion combinations generated in step 202. The complete synthetic program can be, for example, a recombination of code portions that results in another memory management program that includes different code portions compared to an originally used memory management program that was previously broken down into code portions. For example, different versions of memory allocation functions, such as memalloc 1 and memalloc2 can be used as part of different code portion combinations, resulting in different recombined synthetic programs.

The method of FIG. 2 also includes training 206 an artificial intelligence system using the synthetic programs. Training an artificial intelligence system using the synthetic programs can include training an artificial intelligence model, machine learning model, deep learning model, or generative AI model such as a large language model (LLM) using the synthetic programs as a training data set. Synthetic program module 107 can be configured to train an AI system in different ways. For example, training an AI system can include providing a set of training data set to the AI system and causing the AI system to make decisions or produce outputs based on the training data set. At an initial stage of training, the AI system can be provided with data that is tagged or labeled with metadata that assists the AI system in understanding the type of data and in producing output. Readers will appreciate that an example AI system can be used to take code that is written in one programming language and produce similar code in a second programming language. In such an example, initially, synthetic program module 107 can provide a training data set of code portion combinations that are tagged in particular ways, such as with the programming language used to produce the code in the code portion combinations. Synthetic program module 107 can then prompt the AI system to generate another program based on the training data set, but provide in the prompt or via other metadata an identifier of a different programming language than that used for the training data set. In later training stages, the tagging (e.g., identification of the programming language) can be removed.

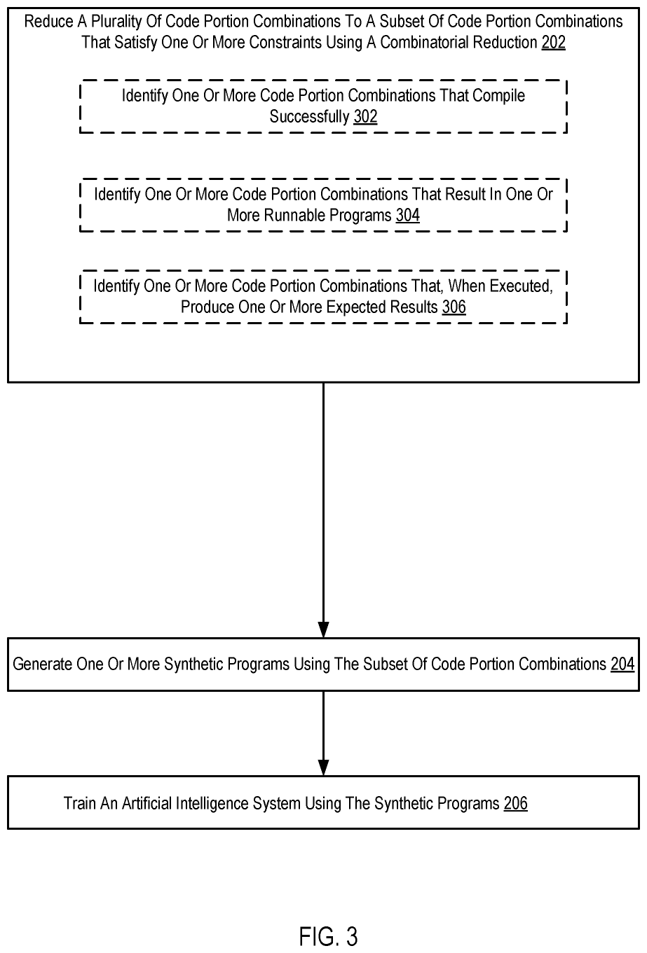

FIG. 3 sets forth a flowchart of another example method for combinatoric code generation for training artificial intelligence systems in accordance with some embodiments of the present disclosure. The method of FIG. 3 is similar to the method of FIG. 2 in that the method of FIG. 3 also includes reducing 202 a plurality of code portion combinations to a subset of code portion combinations that satisfy one or more constraints using a combinatorial reduction, generating 204 one or more synthetic programs using the subset of code portion combinations, and training 206 an artificial intelligence system using the synthetic programs.

The method of FIG. 3 differs from the method of FIG. 2 in that the method of FIG. 3 also includes identifying 302 one or more code portion combinations that compile successfully. Identifying 302 one or more code portion combinations that compile successfully can include processing a synthetic program formed from the code portion combination using a compiler and determining whether the program compiled successfully. For example, as mentioned previously, the code portions may be COBOL code portions and so the synthetic program that is generated from the code portions can also be a COBOL program. Since COBOL is a compiled language, a COBOL compiler can be used to compile the program and synthetic program module 107 can be configured to determine whether the program compiled successfully. In some embodiments, programs that compile successfully can be used for LLM model training whereas other programs that were created using other code portion combinations may not be used for LLM training. Moreover, only a small sample of the subset of code portion combinations can be compiled. Based on results from compilation of the small sample, synthetic program module 107 can determine whether to compile the remaining combinations in the subset.

The method of FIG. 3 also includes identifying 304 one or more code portion combinations that result in one or more runnable programs. Readers will appreciate that certain code may not produce errors at compile time but may produce errors during execution. Accordingly, synthetic program module 107 can be configured to execute synthetic programs generated from one or more of the code portion combinations and check for successful execution before using the synthetic program as part of the training data set for the LLM. For example, the combination may be executed using an integrated development environment (IDE) or other execution environment.

The method of FIG. 3 also includes identifying 306 one or more code portion combinations that, when executed, produce one or more expected results. Readers will appreciate that certain code may execute successfully but produce unexpected results. Accordingly, synthetic program module 107 can be configured to execute one or more programs generated using the code portion combinations and check whether the execution results that are produced align with expected results for the program.

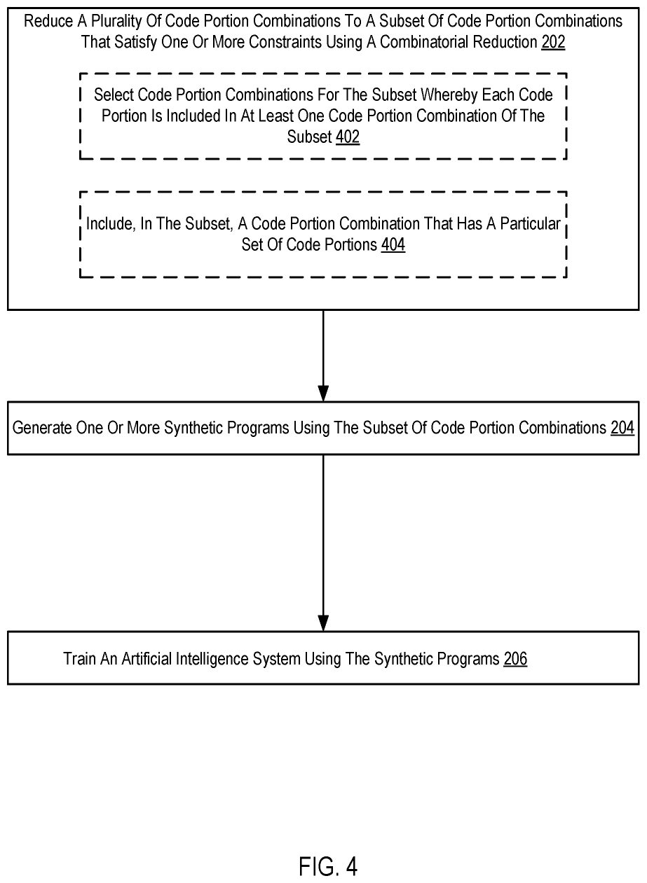

FIG. 4 sets forth a flowchart of another example method for combinatoric code generation for training artificial intelligence systems in accordance with some embodiments of the present disclosure. The method of FIG. 4 is similar to the method of FIG. 2 in that the method of FIG. 4 also includes reducing 202 a plurality of code portion combinations to a subset of code portion combinations that satisfy one or more constraints using a combinatorial reduction, generating 204 one or more synthetic programs using the subset of code portion combinations, and training 206 an artificial intelligence system using the synthetic programs.

The method of FIG. 4 differs from the method of FIG. 2 in that the method of FIG. 4 also includes selecting 402 code portion combinations for the subset whereby each code portion is included in at least one code portion combination of the subset. In some embodiments, synthetic program module 107 can be configured to include, in the subset, code portion combinations such that each code portion is part of at least one code portion combination so that all code portions are used. Readers will appreciate that a code portion may be part of more than one code portion combination. To ensure coverage, synthetic program module 107 may be configured to check that each code portion is part of at least one code portion combination. For example, the code portions may have associated identifiers. Synthetic program module 107 may be configured to store a record (e.g., in some data structure like a table) of identifiers for each code portion that was included in a code portion combination as part of the combinatoric operations that generated the code portion combinations. As an example, synthetic program module 107 can ensure that each n-wise configuration (e.g., a 2-wise configuration for a pairwise reduction, or a 3-wise configuration for a three-wise reduction) is included in at least one code portion combination.

Synthetic program module 107 may be further configured to compare the set of included code portions to the set of code portions that were created in the initial decomposition of code files into code portions. The comparison can reveal whether any code portions were missed and not included in any code portion combination. If so, synthetic program module 107 can generate another code portion combination that includes the missing code portion.

The method of FIG. 4 also includes 404, in the subset, a code portion combination that has a particular set of code portions. Readers will appreciate that certain code portions may form an important component of a synthetic program that is being generated for some purpose. For example, a particular memory allocation function may be an important component of a memory management program that is being generated. Accordingly, synthetic program module 107 may be configured to generate a code portion combination that results in a synthetic program that includes the particular memory allocation function. Moreover, in some cases, synthetic program module 107 can be configured to use a combinatoric engine to generate the code portion combinations. In such cases, synthetic program module 107 can provide the combinatoric engine with a set of code portions and certain constraints, such as a constraint that certain code portions are to be included in any code portion combinations generated by the combinatoric engine.

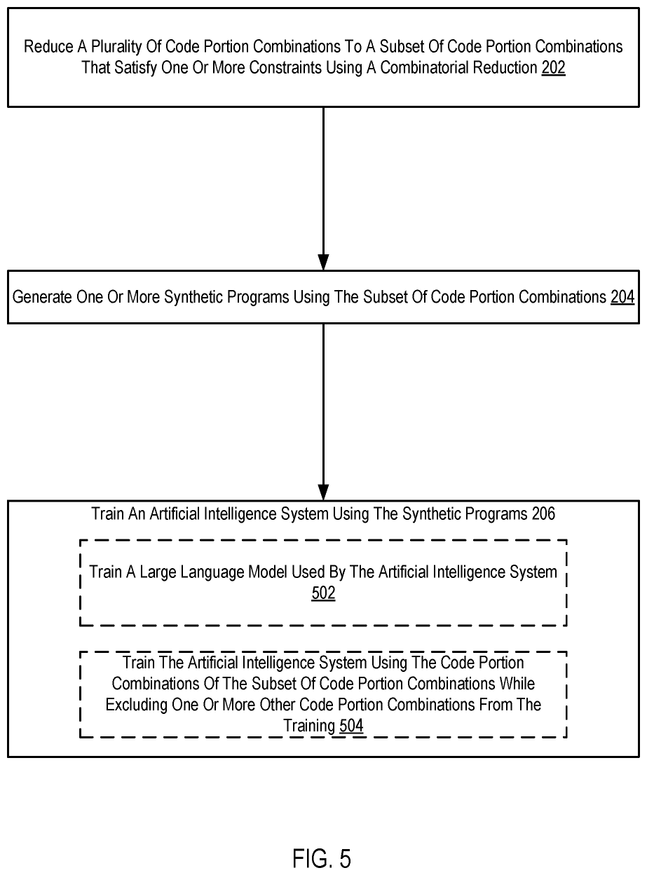

FIG. 5 sets forth a flowchart of another example method for combinatoric code generation for training artificial intelligence systems in accordance with some embodiments of the present disclosure. The method of FIG. 5 is similar to the method of FIG. 2 in that the method of FIG. 5 also includes reducing 202 a plurality of code portion combinations to a subset of code portion combinations that satisfy one or more constraints using a combinatorial reduction, generating 204 one or more synthetic programs using the subset of code portion combinations, and training 206 an artificial intelligence system using the synthetic programs.

The method of FIG. 5 differs from the method of FIG. 2 in that the method of FIG. 5 also includes training 502 a large language model used by the artificial intelligence system. In particular, training the LLM can include different phases, which can be performed individually, as a group, in a sequence, or in any suitable configuration. In a pre-training phase, code portions may be provided as token inputs to the LLM and the LLM can be configured to predict a next token, such as a next code portion. In another phase, also referred to as a supervised fine-tuning or instruction tuning phase, the LLM can be provided with a full synthetic program (such as a code portion combination that is complete program or code file) and is provided with a sample output as a target output. The LLM can then be trained to generate complete programs as responses that minimize the difference between its output and the provided sample output. In yet another phase, the LLM can be trained using reinforcement learning, wherein which is another fine-tuning step to align the model outputs with certain preferences or configuration parameters. For example, the LLM can be trained to output complete programs that comply with certain preferences, such as outputting code files in a certain programming language, or using other constraints.

The method of FIG. 5 also includes training 504 the artificial intelligence system using the code portion combinations of the subset of code portion combinations while excluding one or more other code portion combinations from the training. As noted above, a large number of code portion combinations can be created from a set of code portions (e.g., the Cartesian product of a set of 8 pairs of code portions can be 256 code portion combinations). However, in some embodiments, only the subset of code portion combinations resulting from a combinatoric reduction of the total set of code portion combinations is used for AI training. For example, only the subset of code portion combinations resulting from an n-wise (e.g., pair-wise) combinatoric reduction of the total set of code portion combinations is used for AI training.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of combinatoric code generation for training artificial intelligence systems, comprising:
reducing a plurality of code portion combinations to a subset of code portion combinations that satisfy one or more constraints using a combinatorial reduction;
generating one or more synthetic programs using the subset of code portion combinations; and
training an artificial intelligence system using the synthetic programs.

2. The method of claim 1, wherein reducing the plurality of code portion combinations to the subset of code portion combinations using the combinatorial reduction further comprises:
performing an n-wise reduction of the plurality of code portion combinations.

3. The method of claim 1, wherein reducing the plurality of code portion combinations to the subset of code portion combinations using the combinatorial reduction further comprises:
identifying one or more code portion combinations that compile successfully.

4. The method of claim 1, wherein reducing the plurality of code portion combinations to the subset of code portion combinations further comprises:
identifying one or more code portion combinations that result in one or more runnable programs.

5. The method of claim 1, wherein reducing the plurality of code portion combinations to the subset of code portion combinations further comprises:
identifying one or more code portion combinations that, when executed, produce one or more expected results.

6. The method of claim 1, wherein the plurality of code portion combinations are generated using a plurality of code portions, and wherein reducing the plurality of code portion combinations to the subset further comprises:
selecting code portion combinations for the subset whereby each code portion is included in at least one code portion combination of the subset.

7. The method of claim 1, wherein reducing the plurality of code portion combinations to the subset of code portion combinations further comprises:
including, in the subset, a code portion combination that has a particular set of code portions.

8. The method of claim 1, wherein training the artificial intelligence system includes training a large language model used by the artificial intelligence system.

9. The method of claim 1, wherein training the artificial intelligence system comprises training the artificial intelligence system using the code portion combinations of the subset of code portion combinations while excluding one or more other code portion combinations from the training.

10. A computer program product comprising a computer readable storage medium, wherein the computer readable storage medium comprises computer program instructions that, when executed:
reduce a plurality of code portion combinations to a subset of code portion combinations that satisfy one or more constraints using a combinatorial reduction;
generate one or more synthetic programs using the subset of code portion combinations; and
train an artificial intelligence system using the synthetic programs.

11. The computer program product of claim 10, further comprising computer program instructions that, when executed:
perform an n-wise reduction of the plurality of code portion combinations.

12. The computer program product of claim 10, wherein instructions for reducing the plurality of code portion combinations to the subset of code portion combinations using the combinatorial reduction further comprise instructions to:
identify one or more code portion combinations that compile successfully.

13. The computer program product of claim 10, wherein instructions for reducing the plurality of code portion combinations to the subset of code portion combinations further comprise instructions to:
identify one or more code portion combinations that result in one or more runnable programs.

14. The computer program product of claim 10, wherein instructions for reducing the plurality of code portion combinations to the subset of code portion combinations further comprise instructions to:
identify one or more code portion combinations that, when executed, produce one or more expected results.

15. The computer program product of claim 10, wherein the plurality of code portion combinations are generated using a plurality of code portions, and wherein instructions for reducing the plurality of code portion combinations to the subset further comprise instructions to:
select code portion combinations for the subset whereby each code portion is included in at least one code portion combination of the subset.

16. An apparatus comprising:
a processing device; and
memory operatively coupled to the processing device, wherein the memory stores computer program instructions that, when executed, cause the processing device to:
reduce a plurality of code portion combinations to a subset of code portion combinations that satisfy one or more constraints using a combinatorial reduction;
generate one or more synthetic programs using the subset of code portion combinations; and
train an artificial intelligence system using the synthetic programs.

17. The apparatus of claim 16, further comprising computer program instructions that, when executed:
perform an n-wise reduction of the plurality of code portion combinations.

18. The apparatus of claim 16, wherein instructions for reducing the plurality of code portion combinations to the subset of code portion combinations using the combinatorial reduction further comprise instructions to:
identify one or more code portion combinations that compile successfully.

19. The apparatus of claim 16, wherein instructions for reducing the plurality of code portion combinations to the subset of code portion combinations further comprise instructions to:
identify one or more code portion combinations that result in one or more runnable programs.

20. The apparatus of claim 16, wherein instructions for reducing the plurality of code portion combinations to the subset of code portion combinations further comprise instructions to:
identify one or more code portion combinations that, when executed, produce one or more expected results.
